(19) United States
(12) Patent Application Publication
(10) Pub. No.: US 2025/0173329 A1
(43) Pub. Date: May 29, 2025

(54) SYSTEMS AND METHODS FOR IMPROVED OPERATIONS WITH GENERATIVE ARTIFICIAL INTELLIGENCE

(71) Applicant: Wells Fargo Bank, N.A., San Francisco, CA (US)

(72) Inventors: Ashish B. Kurani, Hillsborough, CA (US); Shobha Duggirala, San Francisco, CA (US)

(73) Assignee: Wells Fargo Bank, N.A., San Francisco, CA (US)

(21) Appl. No.: 18/961,967

(22) Filed: Nov. 27, 2024

Related U.S. Application Data
(60) Provisional application No. 63/604,063, filed on Nov. 29, 2023.

(51) Int. Cl. G06F 16/242; G06F 16/93

(52) U.S. Cl. CPC G06F 16/243; G06F 16/93

(57) ABSTRACT

Systems and methods for improved operations with generative artificial intelligence may include a computing system which identifies a communication metric corresponding to a type of a communication from a device interacting with the computing system. The computing system may extract, from the communication, one or more instructions having a structure according to natural language. The computing system may generate, based on the one or more instructions and the structure, a sentiment metric that indicates a characteristic of the interaction between the device and the computing system. The computing system may select, based on the communication metric and the sentiment metric, a mode of operation of an artificial intelligence circuit of the computing system. The computing system may generate, via the artificial intelligence circuit operating according to the selected mode of operation, one or more responses having the structure based on the one or more instructions.

### CROSS-REFERENCE TO RELATED PATENT APPLICATION

This application claims the benefit of and priority to U.S. Provisional Application No. 63/604,063, filed Nov. 29, 2023, which is incorporated herein by reference in its entirety and for all purposes.

### TECHNICAL FIELD

The present disclosure relates to systems and methods for an intelligent banking service. More specifically, the present disclosure relates to systems and methods of providing curated datasets according to data from disparate data sources using an intelligent banking service which leverages artificial intelligence (AI) modeling and cross-platform data to provide real-time or nearly real-time information in response to inquiries.

### BACKGROUND

Business operations are increasingly complex and increasingly distributed across physical locations, computer systems, and business teams. Due to these trends, responsive interactions within business organizations and between business organizations and outside parties (including customers) is increasingly difficult. In addition, customers and outside parties increasingly demand more nuanced communication and higher responsiveness, increasing complexity of systems and demands beyond human capability to achieve manually.

### SUMMARY

At least one aspect is directed to a method. The method can include identifying, by a computing system, a communication metric corresponding to a type of a communication from a device. The method can include extracting, by the computing system and from the communication, one or more instructions having a natural language structure. The method can include generating, by the computing system and based on the one or more instructions and the natural language structure, a sentiment metric that indicates a characteristic of the interaction between the device and the computing system. The method can include selecting, by the computing system and based on the communication metric and the sentiment metric, a mode of operation of an artificial intelligence circuit of the computing system. The method can include generating, by the computing system and via the artificial intelligence circuit operating according to the selected mode of operation, one or more responses having the natural language structure based on the one or more instructions.

At least one aspect is directed to a computing system including one or more processors. The one or more processors may be configured to identify a communication metric corresponding to a type of a communication from a device interacting with the computing system; extract, from the communication, one or more instructions having a natural language structure; generate, based on the one or more instructions and the natural language structure, a sentiment metric that indicates a characteristic of the interaction between the device and the computing system; select, based on the communication metric and the sentiment metric, a mode of operation of an artificial intelligence circuit of the computing system; and generate, via the artificial intelligence circuit operating according to the selected mode of operation, one or more responses having the natural language structure based on the one or more instructions.

At least one aspect is directed to a non-transitory computer readable medium storing instructions that, when executed by one or more processors of a computing system, cause the computing system to perform operations including: identifying a communication metric corresponding to a type of a communication from a device interacting with the computing system; extracting, from the communication, one or more instructions having a natural language structure; generating, based on the one or more instructions and the natural language structure, a sentiment metric that indicates a characteristic of the interaction between the device and the computing system; selecting, based on the communication metric and the sentiment metric, a mode of operation of an artificial intelligence circuit of the computing system; and generating, via the artificial intelligence circuit operating according to the selected mode of operation, one or more responses having the natural language structure based on the one or more instructions.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

Before turning to the Figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

FIG. 1 is a schematic diagram of a computing system for providing an intelligent banking service, according to an exemplary embodiment.

FIG. 2 is a diagram of a data flow for the computing system of FIG. 1, according to an exemplary embodiment.

FIG. 3 is a diagram of an output generation engine of the computing system of FIG. 1, according to an exemplary embodiment.

FIG. 4 is a diagram of a staged processing flow for providing custom curated information in one or more formats (e.g., as a report), according to an exemplary embodiment.

FIG. 5A-FIG. 5B are example user interfaces showing a query to and response from the computing system of FIG. 1, according to an exemplary embodiment.

FIG. 6A-FIG. 6F are example user interfaces showing a dialogue with the computing system of FIG. 1, according to an exemplary embodiment.

FIG. 7 is a flowchart showing an example method of providing an intelligent banking service, according to an exemplary embodiment.

FIG. 8 is a diagram of a flow to identify a sentiment metric for an interaction with an AI engine, according to an exemplary embodiment.

FIG. 9 is a diagram of a flow to interact with an AI engine according to a sentiment metric, according to an exemplary embodiment.

FIG. 10 is a diagram of a flow to identify a flow from characteristics of one or more objects, according to an exemplary embodiment.

FIG. 11 is a diagram of a flow to generate a summary of a flow for one or more objects, according to an exemplary embodiment.

### DETAILED DESCRIPTION

In various embodiments, this disclosure relates to providing improvements to artificial intelligence-based communication with end-users. The systems and methods described herein may be implemented in various technologies or use cases which may benefit from adaptable, sentiment-based communications. For example, the systems and methods described herein may be implemented in aspects of corporate operations (“COO”), which can be augmented with various computer systems and artificial intelligence systems as discussed herein. For example, COO can include call centers, complaints management, and policies writing.

In a call center scenario, this disclosure is directed to leveraging generative artificial intelligence (“AI”) to identify a next-best action, sentiment, and automation thereof. For example, an AI engine can determine and perform a next-best action by analyzing past actions and current context of a customer via at least one large language model (LLM) to suggest responses or product suggestions. For example, an AI engine can determine sentiment by analyzing speech patterns of a customer, to determine sentiment early to adjust their approach. For example, the AI engine can determine a user state (e.g., by applying an audio signal relating to the speech to a speech-to-text engine to convert the speech to phenomes, implement text processing to tokenize the phenomes into words or phrases, and use a natural language processing (NLP) engine to categorize the words or phrases into sentiment (e.g., positive, neutral, or negative sentiment)). The AI engine can be configured to apply the user state to a value (e.g., a score), to determine an overall user sentiment, and may implement different actions based on the value (e.g., score) as compared to a threshold. For example, if the speech pattern indicates that the customer is not in a good mood (e.g., the score satisfies a threshold criterion relating to a “bad mood”), the AI engine can prevent performance of certain actions relating to responses, until sentiment meets a defined range of emotions (e.g., the score satisfies a different threshold criterion). In this regard, the systems and methods described herein may implement a technical improvement to interactions between an AI engine and an end-user, by using a score which is related to sentiment as a factor in determining a next-best action.

Additionally, the systems and methods according to this disclosure can include automation to identify frequently asked questions (“FAQs”) that commonly come up and deploy automated responses to those FAQs. For example, the AI engine can determine what a customer needs or wants based on the accounts of the customer (e.g., brokerage account, mortgage account). The AI engine can include at least one LLM to tailor an interaction model based on an account history of a given customer.

In a complaints management scenario, this disclosure is directed to leveraging generative AI to automate various actions, determine sentiment, determine resolution confidence of a given response to a complaint, determine a root cause of a complaint, and select complaint channels. The AI engine may be configured to access different communication channels or routings, and use the score determined for a particular user as a proxy for selecting a particular communication channel in which to route the user for further communications. For example, an AI engine can determine a route to an appropriate person to field the complaint and provide data to the person to understand the complaint and the customer. The AI engine can generate and provide to that person a readout to compress the time to resolution of the complaint. This can result in a technical improvement to reduce bandwidth of communication network, because each phone call requires bandwidth and costs money, and a reduction in call length is a reduction in both network congestion and cost. Additionally, the AI engine can achieve automation to log and route a complaint to correct areas based upon generative AI analysis, to compress time to resolution. As described herein, the AI engine can determine sentiment, by analyzing text patterns in complaints to determine sentiment. For example, an AI engine can determine resolution confidence of a given response to a situation, (e.g., a complaint or request) by placing a score on each situation to predict the ability to resolve and prioritize the queue (of complaints) accordingly. For example, within the context of complaint routing, the AI engine can determine root cause of a complaint by analyzing customer complaint data to formulate a root cause theory and then determine a path of action to resolve the customer complaint, thereby reducing the total number of interactions and reducing routing of customer complaints to an optimized path and resulting in reduced use of bandwidth and communication resources. Then, the AI engine can select one or more appropriate channels (e.g., complaint channels) from among interactions with a customer initiated via a branch, text message, email, call center, or VR headset, but is not limited thereto.

In a policy writing scenario, this disclosure is directed to leveraging generative AI to validate compliance, by, for example, using the AI engine to leverage at least one LLM to generate content and documents directed to given policies, simplify language associated with a given policy, validate and manage version control of generated content to keep policies up to date, etc. For example, an AI engine can validate compliance by checking policies against a regulatory framework to ensure ongoing compliance. For example, an AI engine can generate content and documents directed or given policies by analyzing subject matter expert (“SME”) data from a large data set in order to suggest optimal policies. For example, an AI engine can simplify language associated with a given policy to ensure that policy language is written in a way that people will understand. For example, an AI engine can identify unclear language and suggest modification to text or modify text with shorter words, synonyms, or shorter equivalent phrases. For example, an AI engine can date and manage version control of generated content to keep policies up to date, to ensure that up to date policies percolate through the org to all relevant areas. For example, an AI engine can detect and resolve policy conflict based on natural language of the policies. For example, the AI engine can provide a summary or description of roles and recommendation for merging various roles or policies without conflict. For example, the AI engine can identify or modify policies to be consistent with each other, by analyzing all or mostly all policies, identifying conflicts, and resolving conflicts. For example, the AI engine can generate new policies, including to add, delete, revise existing policies in response to feedback to the AI engine regarding how closely policies are being followed. For example, the AI engine can explain policy in a way that is easy-to-understand, by generating text that is simplified as discussed herein.

The systems and methods described herein may leverage advanced computing techniques to enhance the interaction between a device and a computing system. For instance, by identifying a communication metric corresponding to the type of communication, the system can tailor its responses more effectively. This ensures that the system can handle various types of communications, such as text, voice, or other forms, with greater accuracy and efficiency. The ability to extract instructions with a natural language structure further enhances the AI engine's capability to understand and process user inputs, improving the overall user experience. For example, where the AI engine generates a sentiment metric, the system may be configured to gauge an emotional tone or sentiment of the interaction, which in turn enables it to respond in a contextually appropriate manner.

Furthermore, selecting a mode of operation for the AI engine (or circuit) based on both the communication metric and the sentiment metric provides a technical advantage over other systems. The dynamic selection process based on communication and sentiment metrics may facilitate operation of the system in a suitable mode for the given context, thereby optimizing performance and resource utilization. By generating responses that maintain the natural language structure of the original instructions, the system can provide more coherent and relevant replies, which in turn enhances the effectiveness of the communication. Overall, such technical benefits contribute to a more intelligent, responsive, and user-friendly computing system.

Another example of the technical benefits provided by the systems and methods described herein is the ability to dynamically adapt the AI circuit's mode of operation based on real-time data. For example, by analyzing sentiment of the communication between an end-user and the AI engine, the systems and methods described herein may be configured to operate in different modes which changes the allocated computational resources, leading to improved performance and reduced latency. By optimizing the AI circuit's operation, the system can handle high volumes of interactions without compromising on response quality or speed based on the given context and sentiment of communication. Additionally, by adapting the scoring of various communication (e.g., used to determine the context and sentiment), the systems and methods described herein may improve (e.g., learn) over time, through refinement of natural language processing and sentiment analysis algorithms, to enhance the AI engine's understanding of natural language structures and sentiment metrics. Such a continuous learning process causes the systems and methods described herein to be more accurate and effective in its responses, providing a more personalized and engaging user experience.

Additionally, by implementing natural language processing (NLP) and sentiment analysis, the systems and methods described herein may improve on other LLMs, to accurately interpret and respond to complex user inputs, making it more versatile and capable of handling diverse communication scenarios. For example, such combination of improvements, yields an improved LLM which is configured to generate responses not just according to the content of the communication, but also to the emotional context, thereby improving on other LLMs which may just respond based on the content itself.

The systems and methods described herein also promote scalability and flexibility. The modular nature of the system allows for streamlined updates and enhancements, ensuring that the system can keep pace with evolving technological advancements and user needs. This scalability is particularly beneficial for applications in dynamic environments where the volume and nature of interactions can vary significantly, such as call center environments, as one example. In sum, the combination of advanced computing techniques, real-time adaptability, continuous learning, and robust NLP and sentiment analysis capabilities provide a cutting-edge solution in the field of AI and human-computer interaction. These and other features and benefits are described more fully herein below.

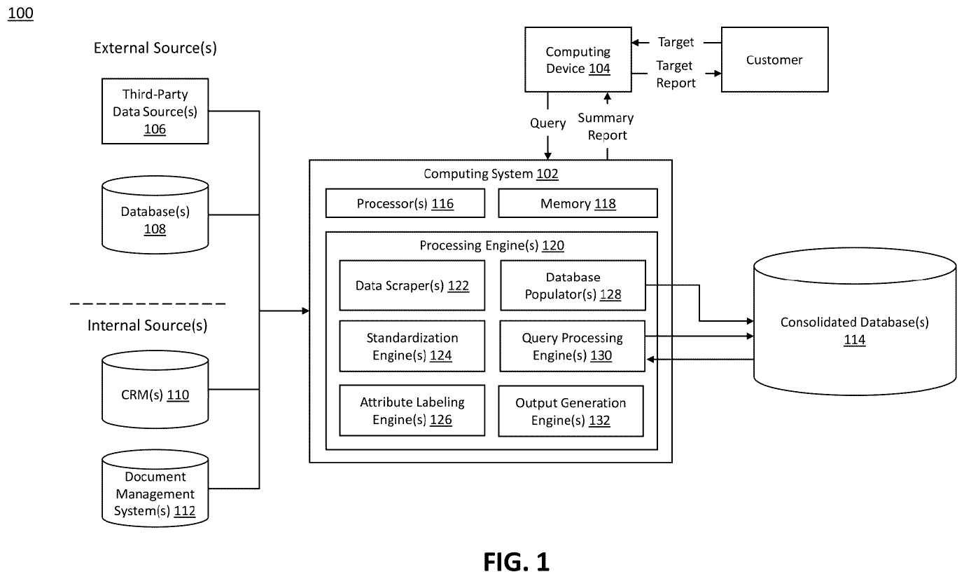

Referring now to FIG. 1, depicted is a block diagram of a system 100 for providing curated datasets across disparate data sources, according to an exemplary embodiment. The system 100 may include a computing system 102 (which may include or provide an intelligent banking service) communicably coupled to a computing device 104 and various data sources. The data sources may include, for example, external data sources (e.g., third-party data sources 106, databases 108, etc.) and internal data sources (e.g., customer relationship management (CRM) platforms 110, document management system(s) 112, etc.). As described in greater detail below, the computing system 102 may be configured to populate at least one consolidated database (or databases) 114 using standardized, labeled (or tagged) data from the data sources. The computing system 102 may be configured to receive a query from the computing device 104, pull data from the consolidated database(s) 114, and generate a response to the query.

The system 100 may include at least one computing device 104. The computing device 104 may be or include any type or form of a computing device, such as a personal computer, laptop, mobile device, smartphone, tablet, or any other device. In some embodiments, the computing device 104 may be operated by a user associated with a provider/entity of the computing system 102 (e.g., such that the user has access to the internal sources). In some embodiments, the computing device 104 may be operated by a third-party user (e.g., an end-user, an investor, etc.). As described in greater detail below, the user may generate a query (e.g., via a client application associated with the computing system 102). In various embodiments, the computing system 102 may be configured to apply various policies/access rights to the user (e.g., based on the particular user, the type of user, etc.), for generating the response to the query.

The computing system 102 may be configured to access various external sources. The external sources may include third-party data sources 106 and databases 108. In various embodiments, the external sources may provide financial industry information used for data collection, research, analysis, market insights, and/or analytics purposes. The third-party data sources 106 and databases 108 may include one or more of, for example and non-exhaustively, FactSet, Refinitiv, CapIQ, S&P, Moody's, Bloomberg, Markit, Syndtrak, Dunn & Bradstreet, Edgar, etc. The computing system 102 may be configured to access various internal sources. The internal sources may include, for example, CRM(s) 110, document management systems 112, internal databases, etc. In various embodiments, the internal sources may be configured to maintain and provide various internally generated and maintained financial industry information, such as customer or deal-specific information (e.g., maintained in the CRM(s) 110), internal deal books, bookbuild platform, or the like.

The computing system 102 may ingest data corresponding to various industries and sub-industries (e.g., banking, consumer and retail, diversified financials, energy and power, healthcare, industrials, real estate, gaming, lodging and leisure, technology, media, and telecommunications, to name a few non-limiting possibilities). The computing system 102 may ingest external data elements (e.g., from the external sources 106, 108) including public financials, public filings, client capitalization, enterprise value, equity value, projections, trading levels, assets, indices, press releases, transcripts, company and debt ratings, interest rates, secondary trading levels, deal document data rooms for banks/investors, fundamental data (20 years history), security prices (daily), ownership fragmentation, shareholder voting pattern (voting topics and takeover correlations), analyst recommendations, management turnover, governance ratings, ESG scores, and journey and targets of previous acquisitions, to name a few possibilities. The computing system 102 may ingest internal data elements (e.g., from internal sources CRM(s) 110, document management systems 112) including company contact information, industry or sector information, compliance decisions and fees, deal or coverage teams from the institution, deal documents (e.g., lender presentations, term sheets, credit agreements, merger agreements, fee letters, commitment letters), investors in deal (e.g., at closing), historical deals (e.g., pricing, size, covenants, maturity date), to name a few possibilities.

The computing system 102 may be owned by, associated with, or otherwise operated by a provider institution (e.g., a bank, a credit union, or other financial institution). The provider institution may be associated with the computing device 104. For example, the computing system 102 may be a computing system of the provider institution, and the computing device 104 may be operated by or associated with an employee, banker, or other user associated with provider institution.

The computing system 102 may include a processing circuit including one or more processor(s) 116 and one or more memory devices 118. The processor(s) 116 may be implemented or performed with a single or multi-chip processor, a digital signal processor (DSP), an application specific integrated circuit (ASIC), one or more field programmable gate array (FPGAs), or other suitable electronic processing components. A processor may be a microprocessor, or, any other suitable processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the circuits of the processor 116 may include or otherwise share the same processor which, in some example embodiments, may execute instructions stored, or otherwise accessed, via different areas of memory). Alternatively, or additionally, the one or more processors 116 may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The processing circuit may include at least one memory 118. The memory 118 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 118 may be or include tangible, non-transient volatile memory or non-volatile memory. The memory 118 may also include database components, object code components, script components, or any other type of information structure for supporting the activities and information structures described in the present application. According to an exemplary embodiment, the memory 118 may be communicably connected to the processor(s) 116 via the processing circuit and includes computer code for executing (e.g., by the processing circuit and/or the processor(s) 116) one or more processes described herein.

The computing system 102 may include one or more processing engines 120. The engines described herein (also referred to herein as a processing circuit, sub-processing circuit, and/or custom information curation and generation processing system or circuit) may be or include any device, component, element, or hardware designed or configured to perform various functions of the computing system 102. In this way, the engines may be one or more dedicated processing circuits for the operations ascribed to them herein. The processing engine(s) 120 may include one or more data scraper(s) 122, standardization engine(s) 124, attribute labeling engine(s) 126, database populator(s) 128, query processing engine(s) 130, and output generation engine(s) 132. In various embodiments, one or more of the processing engines 120 may be combined with one or more other processing engines 120. Additionally, or alternatively, one or more processing engines 120 may be divided or sub-divided into multiple processing engines 120. The processing engine(s) 120 may include, for example, one or more processors of a processing circuit (such as the processor(s) 116) configured by corresponding executable instructions to perform various functions associated therewith.

The computing system 102 may include one or more data scraper(s) 122. The data scraper(s) 122 may be or include any device, component, element, or hardware designed or configured to ingest, receive, retrieve, access, or otherwise scrape data from the internal and external data sources. In some embodiments, the data scraper(s) 122 may be configured to automate the extraction of data from various websites or databases (such as the sources 106-112). In some embodiments, the data scraper(s) 122 may be configured to receive credentials for certain data sources/websites (e.g., where the data sources are password protected or otherwise provide limited access to particular users or user-types). In some embodiments, the data scraper(s) 122 may be configured to scrape data sources/websites based on predefined or desired information. For example, the data scraper(s) 122 may be configured to maintain an association between particular types of data/desired information and corresponding data sources for querying. The data scraper(s) 122 may be configured to transmit, communicate, send, or otherwise provide queries or requests to a target database, accessing the data within the database, and retrieving the desired information. The data scraper(s) 122 may be configured to generate SQL queries or API calls to interact with the database(s) and extract and/or ingest relevant data based on specific criteria or search parameters.

The computing system 102 may include one or more standardization engine(s) 124. The standardization engine(s) 124 may be or include any device, component, element, or hardware designed or configured to standardize data ingested or scraped by the data scraper(s) 122. In various embodiments, because the data scraper(s) 122 may access different data sources which may have different data formats, the standardization engine(s) 124 may be configured to standardize the data formats/values, etc. across the ingested data. The standardization engine(s) 124 may be configured to perform various data mapping and/or transformations to establish a standardized/unified data format across the sources. For example, the standardization engine(s) 124 may be configured to identify common data elements across the data source(s), create a standard schema, and map data from the various data sources according to the standard schema. As another example, the standardization engine(s) 124 may be configured with and/or access various data integration or middleware tools for mapping, transformation, and synchronization. In various embodiments, the standardization engine(s) 124 may be configured to apply the data mapping/transformations/etc. to data ingested by the data scraper(s) 122, to generate a standardized dataset.

The computing system 102 may include one or more attribute labeling engine(s) 126. As alluded to above, the attribute labeling engine(s) 126 may be or include any device, component, element, or hardware designed or configured to determine, assign, apply, or otherwise associate various labels/tags/attributes to data entries of the standardized dataset. In some embodiments, the attribute labeling engine(s) 126 may include or access a machine learning (ML) model or framework for programmatically labeling the data entries of the standardized dataset. For example, the attribute labeling engine(s) 126 may be configured to receive various labeling functions for generating training labels based on various characteristics, rules, etc. The attribute labeling engine(s) 126 may be configured to label or otherwise tag the standardized dataset using the various labeling functions. As one example, the attribute labeling engine(s) 126 may access Snorkel, or some other machine learning framework, for labeling the standardized dataset.

The computing system 102 may include one or more database populator(s) 128. The database populator(s) 128 may be or include any device, component, element, or hardware designed or configured to update, populate, organize, store, or otherwise maintain the consolidated database(s) 114. The database populator(s) 128 may be configured to store the labeled, standardized data entries of the standardized dataset in the consolidated database(s) 114. In this regard, the consolidated database(s) 114 may be or include a database which consolidates data from a plurality of data sources (several of which may have different data formats from other sources). As described in greater detail below, the consolidated database(s) 114 may be or represent training sets used as training sets for a large language model (LLM) or generative artificial intelligence (AI) platform which uses such data for responding to queries to an AI interface.

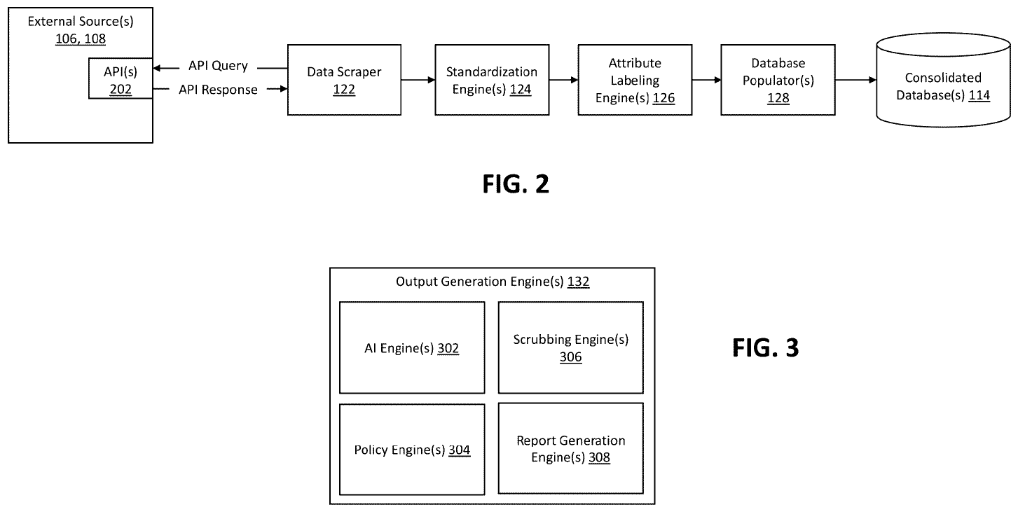

Referring briefly to FIG. 2, depicted is a data flow for the computing system 102, according to an exemplary embodiment. As shown in FIG. 2, the data flow may be used for populating the consolidated database(s) 114. To begin the data flow, the data scraper(s) 122 may be configured to pull data from the external source(s) 106, 108. In some embodiments, as shown in FIG. 2, the data scraper(s) 122 may be configured to pull data from the external data source(s) 106, 108 by transmitting an API query to one or more API(s) 202 of the data source(s) 106, 108, to pull a particular type/format of data. The API(s) 202 may be configured to respond to the query with an API response including the requested data of the external source(s) 106, 108. While described as performing an API query and receiving a response, it is noted that the data from the external source(s) 106, 108 may be retrieved in many different ways, such as using standard query language (SQL) requests, hypertext transfer protocol (HTTP) GET requests, etc.

Once the data scraper(s) 122 receive the API response including the requested data (e.g., as a first or initial dataset), the data scraper(s) 122 may be configured to transmit, communicate, share, or otherwise provide the initial dataset with the standardization engine(s) 124. The standardization engine(s) 124 may be configured to apply various data mapping and transformation algorithms to the initial dataset to generate a standardized dataset. The standardization engine(s) 124 may be configured to provide the standardized dataset to the attribute labeling engine(s) 126. The attribute labeling engine(s) 126 may be configured to apply various machine learning algorithms to the standardized dataset to assign various label(s) to the dataset. The database populator(s) 128 may be configured to receive the standardized, labeled dataset from the attribute labeling engine(s) 126, and populate the consolidated database(s) 114 with the standardized, labeled dataset.

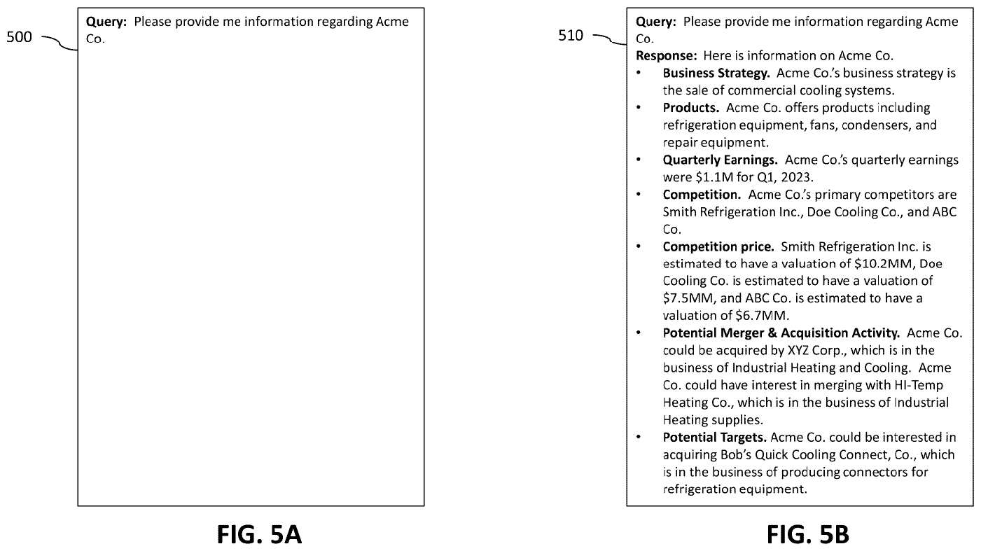

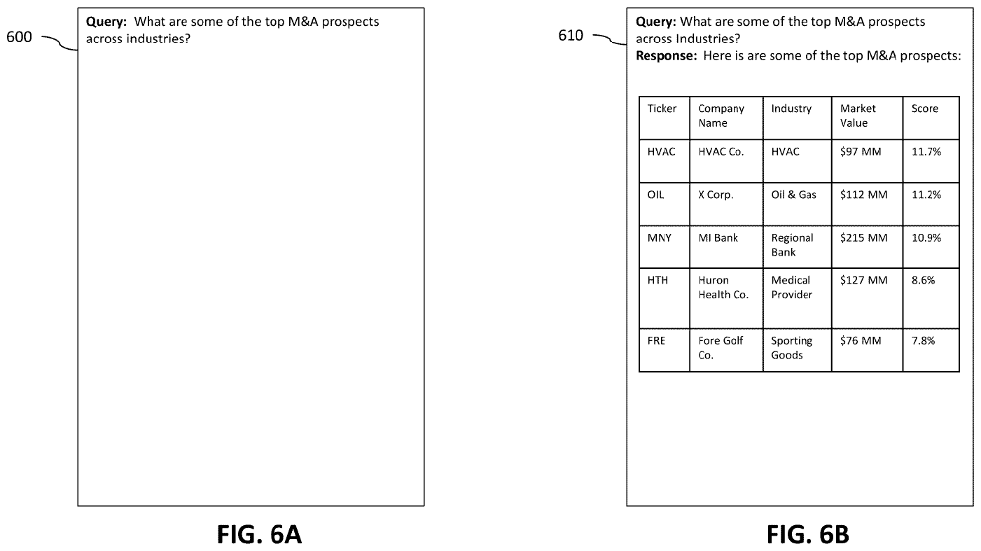

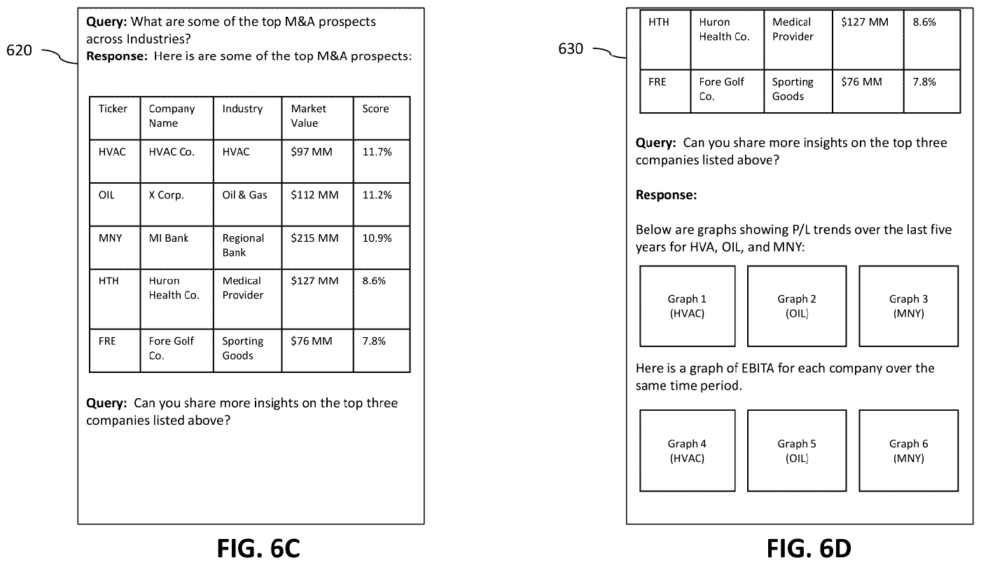

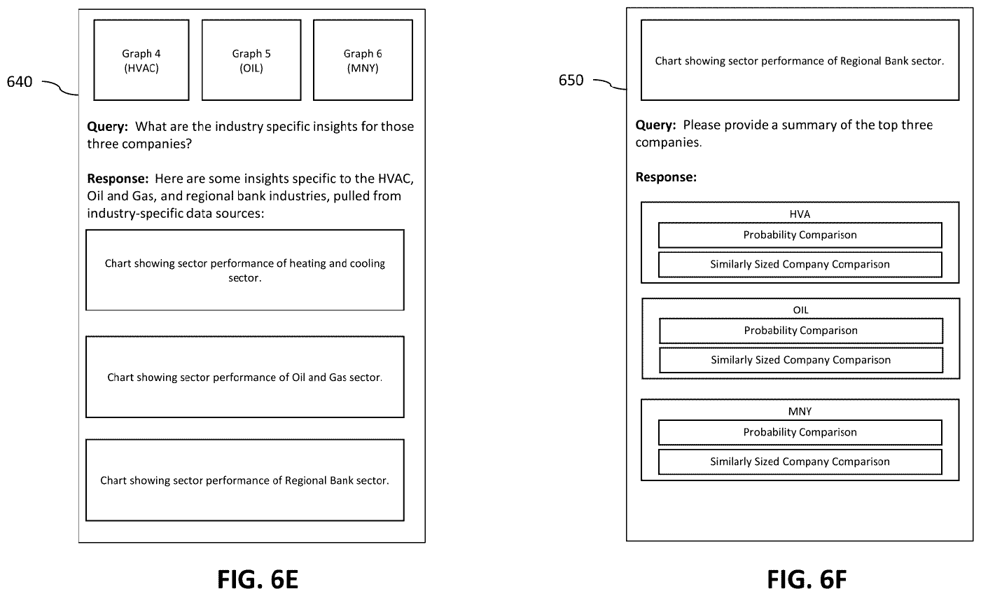

Referring back to FIG. 1, the computing system 102 may include one or more query processing engine(s) 130. The query processing engine(s) 130 may be one or more processing circuits structured or configured to analyze, parse, inspect, or otherwise process an input/prompt/query received from the computing device 104. In some embodiments, the query processing engine(s) 130 may be configured to receive a text input (e.g., query) from the computing device 104. The text input may be or include queries similar to those described below with reference to FIG. 5A-FIG. 6F. The query processing engine(s) 130 may be configured to tokenize the text input into tokens (e.g., phrases or passages, individual words, sub-words, punctuation, etc.). The query processing engine(s) 130 may be configured to transform, convert, or otherwise encode each token generated for the text input into an encoded token. The encoded token may be encoded into a format (such as vector format, word embeddings, etc.) which is compatible with the output generation engine(s) 132, as described in greater detail below.

Referring now to FIG. 1 and FIG. 3, depicted in FIG. 3 is a block diagram of the output generation engine(s) 132 in greater detail, according to an exemplary embodiment. As shown in FIG. 3, the output generation engine(s) 132 may include one or more artificial intelligence (AI) engine(s) 302, one or more policy engine(s) 304, one or more scrubbing engine(s) 306, and one or more report generation engine(s) 308. Like the engines in FIG. 1, the engines 302-308 may be one or more dedicated processing circuits structured or configured to perform various functions associated therewith. In some embodiments, the engines 302-308 may include, for example, one or more processors of a processing circuit (such as the processor(s) 116) configured by corresponding executable instructions to perform various functions associated therewith. Each of these engines 302-308 are described in greater detail below.

The artificial intelligence engine(s) 302 may be one or more processing circuits configured to employ, execute, or otherwise provide various AI-related functions. For example, the artificial intelligence engine(s) 302 may be or include a neural network (such as a generative pre-trained transformer neural network) trained to generate responses to queries. In some embodiments, the neural network may be trained using data from, at least, the consolidated database(s) 114. In this the regard, the neural network(s) may be trained using the standardized, labeled data ingested or otherwise received from the external source(s) 106, 108 and internal source(s) CRM(s) 110, or document management systems 112. In some embodiments, the neural network(s) may be trained using the dataset stored in the consolidated database(s) 114 along with various examples of answers to queries. The neural network(s) may be trained by tokenizing the dataset, initializing the weights and biases of the neural network(s), feeding inputs (e.g., example queries) to the neural network(s) and using a loss function to quantify a discrepancy of the response to the queries generated by the neural network(s) to the answer. The neural network(s) may update the weights/biases based on the output/discrepancy, until the neural network(s) satisfy various testing/training criteria. At the deployment stage, the neural network(s) may be configured to receive the encoded tokenized query as an input (e.g., to an input layer of the neural network(s)), perform forward propagation of the encoded tokens to the neural network, extract features, perform non-linear transformations, perform contextual understanding, and generate an output.

In some embodiments, the artificial intelligence engine(s) 302, upon determining a context of the query, may generate one or more queries for the consolidated database 114 and/or data sources 106-112 to obtain data relevant to the query. The artificial intelligence engine(s) 302 may be configured to retrieve or otherwise request data which is relevant to the information which was requested. For example, if the query asks for financial information relating to a particular company (e.g., Acme Co.), the artificial intelligence engine(s) 302, upon determining that the context of the query is financial information relating to Acme Co., may generate a query to database 114 and/or one or more of the data source(s) 106-112 to obtain information/data relating to Acme Co. The artificial intelligence engine(s) 302 may be configured to supply the data as an input to the artificial intelligence engine(s) 302 for generating various projections/outlook information relating to the query. In this regard, the artificial intelligence engine(s) 302 may be configured to query for real-time or near real-time data as an input, to provide more accurate projections/reports/responses.

The policy engine(s) 304 may be or include any device, component, element, or hardware designed or configured to assess, use, employ, or otherwise apply one or more policies to a query for generating a response. In some embodiments, the policy engine(s) 304 may be configured to apply the policies based on a user which generated the query. For example, the policy engine(s) 304 may be configured to maintain, include, or otherwise access various policies associated with the computing system 102. The policies may be maintained or defined by an enterprise associated with the computing system 102. For example, where the computing system 102 is a financial institution computing system, the policies may be defined or set by the financial institution. The policies may include one or more data access rules for particular users or groups of users, types of users, classifications of users, etc. As one example, the policies may include a data access rule which restricts access to certain types of responses (e.g., responses including data which was obtained or trained from internal source(s) CRM(s) 110, document management systems 112) to only be provided to internal users. When the computing device 104 generates a query, the computing device 104 may be configured to transmit the query with a unique identifier associated with the user of the computing system 102 (e.g., obtained when logging into the computing device 104, when logging into a client application associated with the computing system 102, etc.). The policy engine(s) 304 may be configured to perform a look-up function using the unique identifier, to determine whether any access rights are triggered for the user based on the policy. In some embodiments, the policy engine(s) 304 may be configured to apply a tag, label, or otherwise associate the query with a particular response type (e.g., internal or external response, scrubbed or full response, etc.) based on whether any access rights are triggered.

The scrubbing engine(s) 306 may be one or more processing circuits structured or configured to cleanse, clean, or otherwise scrub the response generated by the AI engine(s) 302 according to the policy (or policies) of the policy engine(s) 304 as applied to the particular user. In some embodiments, the scrubbing engine(s) 306 may be configured to scrub the response, to remove protected or secured data (such as internal data, or data from internal sources). The scrubbing engine(s) 306 may be configured to remove, for example, data from the response which corresponds to data entries tagged as being sourced from the internal source(s). In this regard, the scrubbing engine(s) 306 may be configured to generate modified response(s) which are tailored to the particular audience.

The report generation engine(s) 308 may be configured to generate, determine, derive, or otherwise provide one or more responses (or reports) according to the output from the AI engine(s) 302 (e.g., following scrubbing by the scrubbing engine(s) 306). The report generation engine(s) 308 may be configured to provide the report or responses in various formats, including for example text outputs, table outputs, visual or graphical outputs, and so forth. The report generation engine(s) 308 may be configured to generate the reports or responses to the computing device 104 (e.g., which provided the query to the computing system 102). In some embodiments, the report generation engine(s) 308 may be configured to compile responses to a plurality of queries within a common chain or thread into a single report. For example, the report generation engine(s) 308 may be configured to compile the responses to each of the queries from FIG. 6A-FIG. 6F described below into a single report. Various examples of queries, responses, reports, and the like are described in greater detail below.

Referring generally to FIG. 1, the computing system 102 may be configured to receive various queries and generate corresponding responses. The examples provided below are intended to be illustrative in nature and are not intended to be limiting.

As one example, the computing system 102 may be configured to receive a query requesting predictive financial outcomes for a particular entity or target (or set of targets, for example as part of a merger). The computing system 102 may be configured to ingest (e.g., as an input) current financial information/data of the entities or targets (such as balance sheets, income statements, cash flows, 10 k filings, board presentations, public and private regulatory filings), press or news articles from various third-party data sources, trends, and the like. In various embodiments, the computing system 102 may be configured to ingest a subset of data of interest (e.g., rather than ingesting the entirety of the data). For example, the computing system 102 may be configured to apply various filters to the data types/queries, to limit an amount of ingested data (e.g., which may in turn improve processing speeds by reducing memory occupancy). The computing system 102 may be configured to compare the ingested data (e.g., using the AI engine(s) 302) to similar transactions which was used as training data for generating or forecasting scenarios on the potential performance of the entities (e.g., in the case of a merger, forecast the financial outcome for instances where the merger is completed or does not move forward). The computing system 102 may generate a report which includes or outlines the forecasted scenarios, such as a probabilistic range or outcomes on revenue growth, expense controls, overall strategic value and short term and long-term profitability, and the like.

In various embodiments, the computing system 102 may be configured to incorporate one or more of various constraint(s) to one or more of the query(ies). For example, the computing system 102 may be configured to ingest or leverage (e.g., as part of training and correspondingly response generation) potential regulatory constraints specific to the industry and legal framework of the different countries, to lay out potential risks to having a deal consummate. In various embodiments, depending on a particular risk, the computing system 102 may generate various actions and recommendations for risk mitigation (e.g., how to ensure regulatory compliance leading up to the approval of the merger by the corresponding regulatory or government authorities).

As an example, the computing system 102 may receive a query for candidate mergers and acquisition or activism targets. The computing system 102 may use the output generation engine(s) 132 (e.g., the AI engine(s) 302) to apply as an input, for example, fundamental data, market data, ratings, and/or other metrics. The AI engine(s) 302 may be trained on, for example, fundamental data (e.g., 20-year history), security prices (daily), ownership fragmentation, shareholder voting pattern, analyst recommendations, management turnover, government ratings, ESG scores, journeys and targets of previous acquisitions, etc. The AI engine(s) 302 may also use random forest, gradient boosting machine, or other supervised methods trained on, for example, any number of campaigns or M&A deals, to generate a prediction of whether a target is likely or not to have an activism or M&A event. The output generation engine(s) 132 may be configured to generate a ranked ordered list of M&A targets and/or activism targets.

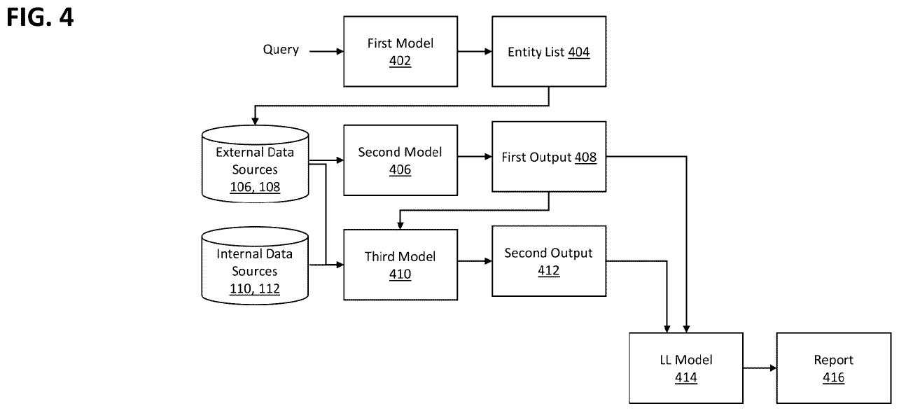

Referring now to FIG. 4, depicted is a staged processing flow for generating a report, according to an exemplary embodiment. The processing flow may be performed by the computing system 102 of FIG. 1. At the outset (e.g., first stage), the computing system 102 may receive a query. Following determining the context of the query (e.g., as described herein), the computing system 102 may apply the query to a first model 402, to determine an entity list 404. For example, the query may be a request for M&A prospects. The entity list 404 may be a list of entities (e.g., top 100 entities, such as privately held or public companies) which are M&A prospects. Following the first stage, the computing system 102 may use the entity list 404 to perform a query of one or more external sources 106, 108, for information relating to each of the entities of the entity list. For example, the computing system 102 may perform a query of the external databases 108 for information relating to the entities. The computing system 102 may apply the responses (e.g., information) from the external databases 108 to a second model 406, to generate a first output 408. The second model 406 may be or include an M&A signals model which is trained to generate an output indicating a likelihood of M&A activity for a particular entity given the information relating to that entity. The second model 406 may generate the first output 408 to include a sub-list of entities which have a likelihood that exceeds a threshold.

Following the second stage and determining the sub-list of entities, the computing system 102 may query internal data sources (such as CRM(s) 110, document management system 112, or other database) along with various external data sources 106, 108 (such as industry databases) for information relating to the sub-list of entities. The computing system 102 may apply the information relating to the sub-list of entities as well as the output of the second model (e.g., at the second stage) to a third model 410. The third model 410 may be configured or trained to combine internal and industry data to augment the output of the sub-list of entities. As such, the third model 410 may be configured to generate a second output 412 which is a sub-list of entities which is augmented by internal and/or industry data. Once the first and second outputs 408, 412 are generated, the computing system 102 may be configured to apply the first and second outputs 408, 412 to a large language model 414 to generate a report 416, as described herein.

Referring generally to FIG. 1 together with FIG. 5A-FIG. 6F, the computing device 104 may render a user interface for facilitating interaction between a user of the computing device 104 and the computing system 102. The user interface may be or include, for example, an artificial intelligence (AI) interface which receives queries from the user and renders responses to the queries generated by the computing system 102. In operation, the computing device 104 may establish a connection or link between the computing device 104 and computing system 102 (e.g., over a network) by providing log-in credentials or other unique identifier associated with the user to the computing system 102. Responsive to authentication/verification, the computing device 104 and computing system 102 may establish a session. As part of establishing the session, the computing device 104 may render a user interface (e.g., based on or according to data received from the computing system 102) including a text field for providing queries. Once the user submits a query, the computing device 104 may communicate the query (or data corresponding to the query) to the computing system 102 over the connection or link of the session. The computing system 102 may process the query as described above, to generate a response. The computing system 102 may transmit the response to the query over the connection or link of the session to the computing device 104, for rendering in the user interface.

Referring now to FIG. 5A and FIG. 5B, depicted are example user interfaces 500, 510 showing a query to and response from the computing system of FIG. 1, according to an exemplary embodiment. As shown in FIG. 5A, a user of the computing device 104 may enter a prompt or query regarding a target associated with a customer (e.g., a customer interested in acquiring the target). In the example of FIG. 5A, the target may be Acme Co. The query may be, for instance, “Please provide me information regarding Acme Co.” The query processing engine(s) 130 may tokenize the query and encode the tokens for applying to a neural network of the AI engine(s) 302. The AI engine(s) 302 may generate a response which includes, for example, a summary of various information regarding the target. The information may include business strategy, products, quarterly earnings, competition, competition prices, potential M&A activity, and potential targets. The AI engine(s) 302 may generate the response based on the training data and inputs described above with reference to FIG. 1. The output generation engine(s) 132 may generate the response (e.g., using a natural language decoding of the output from the AI engine(s) 302) for populating or otherwise including in the user interface 510 as shown in FIG. 5B.

Referring now to FIG. 6A-6F, depicted are example user interfaces 600-650 showing a dialogue with the computing system of FIG. 1, according to an exemplary embodiment. As shown in FIG. 6A-6F, the computing system 102 may use context from previous queries and responses to generate responses. For example, while the initial query (What are some of the top M&A prospects across industries) is fairly general as shown in FIG. 6A, the second query (e.g., to share more insights of the top three companies, as shown in FIG. 6C) builds off the response to the initial query, and the computing system 102 may use the context of the initial query and response to formulate the response to the second query. A user of the computing device 104 may scroll up to view previous responses. In this regard, the queries and responses between the computing device 104 and computing system 102 may be maintained in a thread, and thus may be used as context for subsequent response generation (e.g., by the computing system 102).

In some embodiments, the report generation engine(s) 308 may be configured to generate a report based on the responses to the series of queries. For example, the user interfaces 600-650 may include a user interface element for generating a report (e.g., “Generate Report” button, as one example). Upon receiving the selection, the report generation engine(s) 308 may be configured to generate a report which includes, incorporates information from, summarizes, or otherwise relates to the responses to each query within the thread. For example, the report may include each of the graphics/tables/etc. generated in response to respective queries, a summary of each of the queries, and a summary (e.g., as a title or subject matter summary) of the thread. The computing system 102 may communicate, transmit, or otherwise provide the report to the computing device 104. The user of the computing device 104 may provide the report as a deliverable to a customer or enterprise, use the report for generating a corresponding deliverable (such as a slide deck or some other deliverable), and so forth.

In various embodiments, the computing system 102 may scrub various internal data from the responses according to the audience (e.g., as indicated by a unique identifier or token associated with the computing device 104) (e.g., to remove internal insights, internal data from the summaries, etc.).

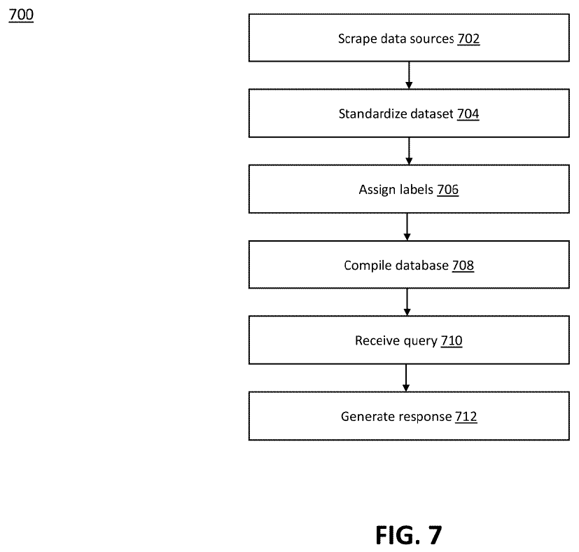

Referring now to FIG. 7, depicted is a flowchart showing an example method 700 of providing an intelligent banking service, according to an exemplary embodiment. The method 700 may be performed by the devices/components/elements described above with reference to FIG. 1-FIG. 6F. As a brief overview, at process 702, a computing system scrapes data sources. At process 704, the computing system generates a standardized dataset. At process 706, the computing system assigns labels. At process 708, the computing system compiles a database. At process 710, the computing system receives a query. At process 712, the computing system generates a response.

At process 702, a computing system scrapes one or more data sources. In some embodiments, the computing system may scrape one or more data sources of the computing system (e.g., internal data sources) and scrape one or more external data sources (e.g., data sources of one or more external computing systems). For example, the computing system may be associated with an institution or enterprise (such as a bank or financial institution). The computing system may scrape data sources of the financial institution, as well as third-party data sources. Such internal data sources may include, for example, customer relationship management (CRM) data sources, document management systems (DMS), deal books, bookbuild platform, past agreements, etc. The external data sources may include, for example, various financial reporting and news sources/databases, such as Factset, Refinitive, CapIQ, S&P, Moody's, Bloomberg, Markit, Syndtrack, D&B, Edgar, etc. The computing system may scrape the internal and external data sources to compile or collect a first dataset. In some embodiments, the computing system may scrape the data sources at various intervals (e.g., daily for certain information, quarterly for other information, yearly for other information, etc.). For example, the computing system may scrape the data sources daily for security prices, news articles, etc., quarterly for earnings reporting, yearly for fundamental data, etc.

At process 704, the computing system generates a standardized dataset. In some embodiments, the computing system may standardize the first dataset (e.g., scraped at process 702) to generate a standardized dataset. The standardized dataset may be or include a dataset which has a common format, structure, or schema across data entries. In some embodiments, the computing system may generate the standardized dataset by performing data mapping and transformations for each data entry of the dataset. At process 706, the computing system assigns labels. In some embodiments, the computing system may assign labels to the data entries of the standardized dataset generated at process 704. The computing system may assign labels to the data entries by applying an artificial intelligence (AI) algorithm to the data entries, to assign labels to the data entries. The AI algorithm may be or include, for example, Snorkel AI, or some other labeling algorithm for data labeling.

At process 708, the computing system compiles a database. In some embodiments, the computing system may compile a database with the standardized dataset having labels assigned thereto. In this regard, the computing system may compile a database with the standardized and labeled data entries (e.g., responsive to performing steps 704 and 706). The computing system may compile the database with data entries which are to be used for AI training (e.g., at the training phase) and for adding context/insights as an input to a trained AI model (or models) at the deployment phase.

At process 710, the computing system receives a query. In some embodiments, the computing system may receive (e.g., via an AI interface) a query from a computing device. The query may be received responsive to the computing device establishing a session with the computing system. In some embodiments, the query may include an inquiry for information relating to an enterprise (e.g., financial information, prospective information, predictions, M&A targets, etc.). At process 712, the computing system generates a response. In some embodiments, the computing system may generate a response to the query for delivering via the AI interface to the computing device.

In some embodiments, the computing system may generate the response by first processing the query. The computing system may process the query by tokenizing the prompt corresponding to the query (e.g., breaking up or dividing the query into words or sub-words), and encoding the tokens of the prompt to have a format which is compatible with an AI model of the computing system (e.g., a vector or numerical representation of the tokens corresponding to the prompt). The computing system may apply the encoded tokens to an AI model trained to determine (at least) a context of the query. Responsive to determining the context, the computing system may generate a query or request to, for example, the database/data sources (e.g., scraped data sources), for contextual information relating to the query. For example, where the context of the query is requesting information relating to a particular company or entity, the computing system may generate a query for the database/data sources for contextual information relating to the particular company or entity. The computing system may receive a response including the contextual information. The computing system may apply the contextual information as an input to the AI model (e.g., as well as the encoded tokens) to generate the response. The response may include information relating to the company (e.g., based on the contextual information) as well as predictions made based on the contextual information (such as predicted financial outlook, likelihood of M&A activity with respect to the company, etc.).

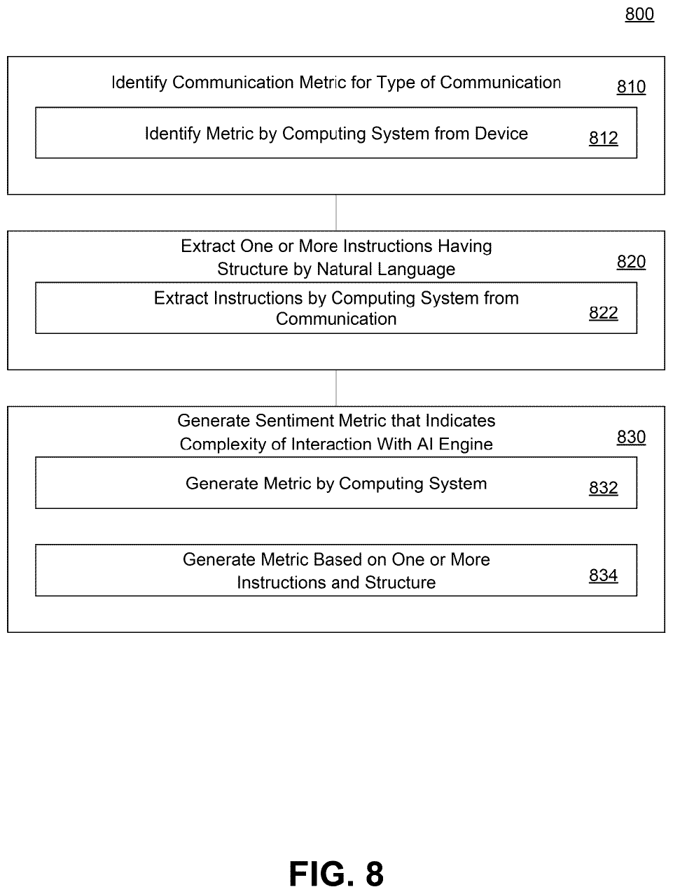

FIG. 8 depicts an example flow to identify a sentiment metric for an interaction with an AI engine, according to an exemplary embodiment. Certain components/systems of the computing system 102 can perform method/process 800. The method 800 can correspond to one or more operations to identify a sentiment that corresponds to a user interaction with an AI engine, based on at least one of a channel of interaction between the user and the AI engine, or a content of interaction provided by the user to the AI engine. A channel of interaction can correspond to a voice call, a text messaging application, a video call, an email, and/or another type of mode/channel of communication between a user (e.g., a customer of the provider institution) and the provider institution computing system 102 (which may include a representative as well). The content of interaction can correspond to semantic or qualitative values of input provided in a message or a call, but is not limited thereto. Generating the sentiment metric, as described herein, allows the computing system 102 to gauge the emotional tone or sentiment of the interaction, causing the AI engine (e.g., the AI engine 302) to respond in a contextually appropriate manner throughout the interaction. Furthermore, such sentiment analysis enhances the intelligence of the AI engine 302 by providing a response not just to the content of the interaction, but also to the emotional context, which creates a human-like interaction.

At process 810, the AI engine 302 identifies a communication metric for a type of a communication. For example, a communication is between a financial institution computing system and a mobile device of a customer. At process 812, the AI engine 302 identifies the metric by a computing system from a device. For example, the communication metric is an identifier of a communication channel. The “identifier” of the communication channel refers to a software address, hardware address that indicates a configuration or a physical structure of the communication channel, and provides an indication of the type of channel between the parties (e.g., email, phone call, text message, and so on). For example, the provider computing system 102 may ascribe certain numeric, alphanumeric, or other values to each interaction session. These values may correlate to the type of communication and, in turn, “identify” the type of communication. The communication metric can also include a property of the communication channel. For example, a property of the communication channel can correspond to a communication protocol, a bandwidth occupancy, a latency indication, and so on.

At process 820, the AI engine(s) 302 extract one or more instructions having a structure according to natural language. At process 822, the AI engine(s) 302 extract the instructions from the communication by the computing system. For example, the AI engine(s) 302 can execute a natural language processor that identifies parts of speech of text according to the English language. The natural language processor assigns tags or labels to words or phrases in the text that indicate the part of speech for that word or phrase. For example, the AI engine(s) 302 tokenize a string according to one or more parts of speech according to a natural language processing engine.

At process 830, the AI engine(s) 302 generate a sentiment metric that indicates a characteristic of an interaction with the provider computing system 102 (e.g., the AI engine(s) 302). For example, the sentiment metric can correspond to a quantitative value generated by the AI engine(s) 302 that is indicative of property of a user. For example, a property of a user is an emotional state of a user. For example, an emotional state can be one of happy, satisfied, unsatisfied, or frustrated, but is not limited thereto. The property of the user can be determined according to one or more tokens of a string that correspond to one or more parts of speech. For example, a part of speech is a noun, verb, article, adjective, or adverb. For example, the method 800 can generate a sentiment metric indicative of a number or percentage of tokens, phrases or words that correspond to one or more sentiment characteristics. A sentiment characteristic refers to an indication of a given emotional state of the interaction. The sentiment characteristic can be linked with one or more given tokens, phrases, or words. For example, a sentiment characteristic can be indicative of a “frustrated” sentiment state, which can be linked with tokens, phrases or words including “refund” or “manager” that are indicative of a frustrated state of a user. As another example, a sentiment characteristic can be a “satisfied” sentiment state, which can be linked with tokens, phrases or words including “Thanks!” or “All set!” that are indicative of a satisfied state of a user.

At process 832, the AI engine(s) 302 generate the metric by the computing system. At process 834, the AI engine(s) 302 generate the metric based on the one or more instructions and the structure. For example, the AI engine(s) 302 generate the sentiment metric according to a natural language structure by identifying a sequence of words that identify words and corresponding parts of speech to match with words and given parts of speech of a given phrase linked with one or more predefined sentiment states. In this way, the provider computing system 102 is continuously assessing an interaction between a customer and the provider computing system 102 to identify the sentiment of the interaction via natural language processing by correlating defined sentiments (e.g., frustrated, content, happy, etc.) with various words, phrase, and/or tones included in the interaction.

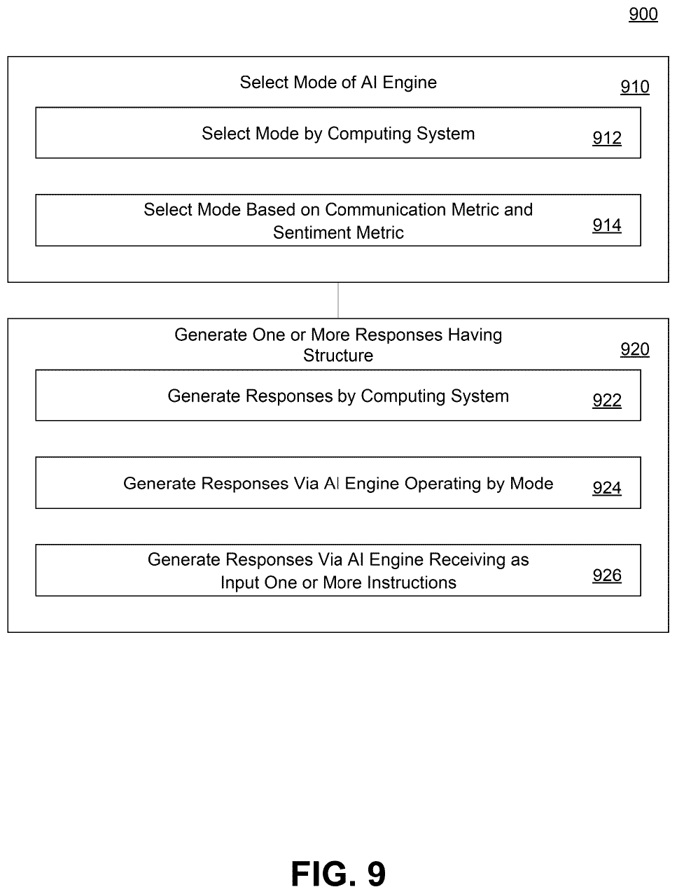

FIG. 9 depicts an example flow diagram of a method 900 of interacting with an AI engine, such as the AI engine(s) 302 of the provider computing system 102, according to a determined sentiment metric as described above with respect to FIG. 8.

At process 910, the AI engine(s) 302 select a mode of the AI engine. More specifically, at process 912, the AI engine(s) 302 select the mode by the computing system. The “mode” may be based on the determined sentiment metric to match interactions with the determined sentiment. For example, the mode can correspond to a “collegial” mode in which the AI engine(s) 302 generate one or more responses according to a first natural language structure. The first natural language structure can correspond to one or more given natural languages (e.g., English, Spanish, Chinese). The mode can correspond to a “corrective” mode in which the AI engine(s) 302 generate one or more responses according to a second natural language structure. For example, a corrective mode is a mode in which the AI engine(s) 302 generate responses that are shorter or more directed to specific actions to take to resolve an issue. For example, a shorter response can be “Will a refund resolve this for you?” or “Will a replacement resolve this for you?” Outside of a corrective mode, the AI engine(s) 302 can provide broader or more open-ended responses, including “What kinds of features do you prefer for this product?” or “How may I help you find what you are looking for today?” At process 914, the AI engine(s) 302 select the mode based on the communication metric and the sentiment metric.

In some embodiments, the AI engine(s) 302 may be configured to switch between modes of operation (e.g., between the “collegial” mode and the “corrective” mode, for example) using at least one of a predefined profile or a machine learning control system. The predefined profile, for example, may relate a particular scenario to a particular mode of operation of the AI engine(s) 302 such that when the particular scenario is identified, the predefined profile provides the corresponding mode of operation of the AI engine(s) 302 to be used in such a scenario. The machine learning control system may be configured to switch the model of operation of the AI engine(s) 302 by analyzing large state spaces and non-linear correlations between variables, such as the determined sentiment of the interaction and the mode of operation of the AI engine(s) 302.

At process 920, the AI engine(s) 302 generate one or more responses having the structure. The AI engine(s) 302 can deliver the responses via one or more communication channels. For example, the AI engine(s) 302 generate a response and transmit the response to the API(s) 202, and the API(s) 202 transmit the response by text message to a text messaging application at the computing device 104. At process 922, the AI engine(s) 302 generate the responses by the computing system. At process 924, the AI engine(s) 302 generate the responses via the AI engine operating according to the mode. At process 926, the AI engine(s) 302 generate the responses via the AI engine receiving as input the one or more instructions.

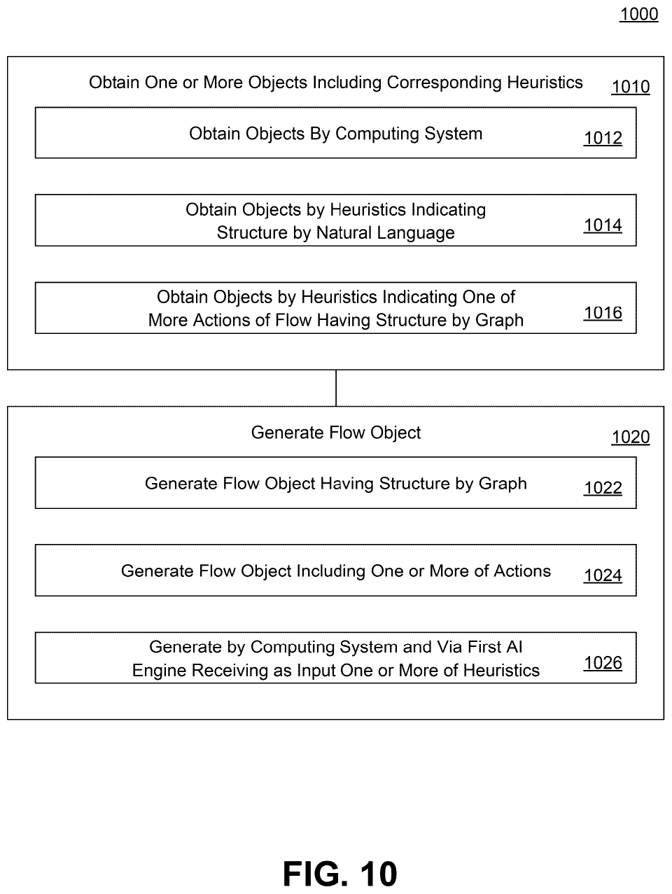

FIG. 10 depicts an example flow 1000 to identify a flow from characteristics of one or more objects, according to an example embodiment. For example, FIG. 10 is directed to a process to generate a policy document via the AI engine(s) 302, based on a plurality of documents each having content related to a policy. The AI engine(s) 302 can obtain these various documents, analyze the content of the documents, and synthesize a policy based on the content of the documents.

At 1010, the AI engine(s) 302 obtain one or more objects including corresponding characteristics. The objects can correspond to one or more data structures indicative of documents, contacts, files, or any combination thereof. The objects may be exchanged during the interaction between the provider computing system 102 and the customer of the provider institution via the communication channel. For example, the AI engine(s) 302 crawl one or more servers of the provider institution via the communication channel to identify one or more documents that have content describing various aspects of a personnel hiring policy. The AI engine(s) 302 then generate a document describing a complete workflow of a personnel hiring policy. At process 1012, the AI engine(s) 302 obtain the objects by a computing system. At process 1014, the AI engine(s) 302 obtain the objects by characteristics indicating a structure according to natural language. For example, characteristics indicative of a structure according to natural language can correspond to given parts of speech. For example, characteristics indicative of a structure according to natural language can correspond to phrases having a sequence of words and given parts of speech associated with each part of speech. At process 1016, the AI engine(s) 302 obtain the objects by characteristics indicating one or more actions of a flow having a structure according to a graph. For example, a graph can correspond to a link between one or more of the data structures. For example, the link can be indicative of an order of operations, a dependency relationship, or any combination thereof.

At process 1020, the AI engine(s) 302 generate a flow object. At process 1022, the AI engine(s) 302 generate the flow object having the structure according to the graph. The flow object can correspond to a sequential arrangement including one or more directed links between one or more objects. For example, the flow object can be a guide document including hyperlinks to supporting documents. The guide document can include a complete description of a process or flow and can reference supporting documents with respect to specific details of the process or flow. For example, a guide document for a personnel hiring policy can include a link to a supporting document describing interview scheduling. For example, the AI engine(s) 302 identify a flow among a subset of data structures indicative of a subset of documents and contacts. In one example, a flow is a folder or smart folder of collected documents that are relevant to a given policy. The AI engine(s) 302 create a flow object corresponding to the subset of data structures based on a selection characteristic to select the subset of data structures. For example, the selection characteristic is a given data domain or security perimeter layer of an organizational computing system. For example, a selection characteristic is a team name, company name, team location, company location, product name, or product type. For example, the subset of data structures are data structures that satisfy the selection characteristic. For example, the AI engine(s) 302 generate a flow object indicative of instructions to complete a particular set of actions directed to a given data domain. For example, the flow object can include a step-by-step list of instructions for completing a hiring process for a given business unit in a company. The data domain can be indicative of an organizational unit, and the selection characteristic can correspond to documents owned by that organization unit. For example, a data domain is a server or workspace associated with a given team or business unit.

At process 1024, the AI engine(s) 302 generate the flow object including one or more of the actions. For example, actions are options to generate interview materials, interview schedules, or the like. For example, the flow object can correspond to a process executable at least partially by a computing system to perform actions according to the domain. At process 1026, the AI engine(s) 302 generate the flow object by the computing system and via a first AI engine receiving as input one or more of the characteristics.

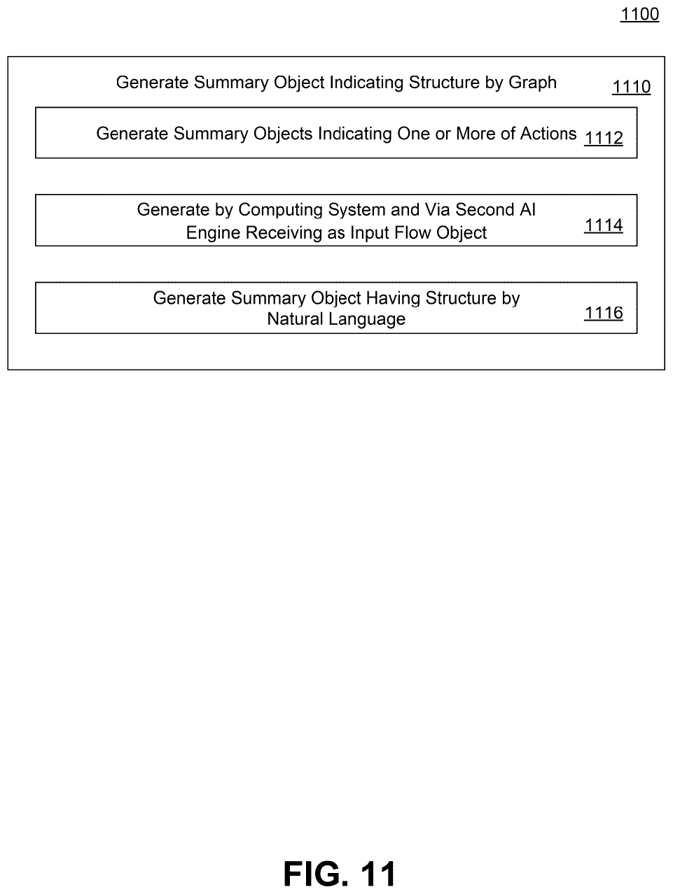

FIG. 11 depicts an example flow to generate a summary of a flow for one or more objects, according to this disclosure. For example, FIG. 11 is directed to generating a workflow for a process in an organization. For example, the workflow can be based on a plurality of documents stored in various folders, drives, or servers. For example, the documents describe various parts of a process or guidelines for completing various tasks or review of various tasks. Here, for example, the AI engine(s) 302 execute a method according to FIG. 11 to synthesize a process from that includes information from various documents that incompletely describe only portions of the process or aspects related to the process (e.g., names or people authorized to approve various actions).

For example, the summary can correspond to narrative text having a structure according to a natural language. At least the computing system 102, or any one or more components thereof, can perform method 1100. At process 1110, the AI engine(s) 302 generate a summary object indicating the structure according to the graph. For example, the narrative text can include a description of a sequence of actions each having an order corresponding to the graph or the flow object. At process 1112, the AI engine(s) 302 generate the summary objects indicating one or more of the actions. At process 1114, the AI engine(s) 302 generate by the computing system and via a second AI engine receiving as input the flow object. At process 1116, the AI engine(s) 302 generate the summary object having the structure according to natural language. Thus, this technical solution can segment a data structure according to a data domain and a natural language structure to provide at least the technical improvement to generate narrative text, beyond the capability of manual means, which is indicative of a graph structure relevant to a domain, regardless of size of the graph structure or complexity of the domain.

For example, the method can include the artificial intelligence engine configured receive as input the one or more instructions having the structure. For example, the AI engine(s) 302 receive text input having a natural language structure and is configured to parse parts of speech tokens in the natural language text input. For example, the method can include a mode corresponding to the complexity and modifying operation of the artificial intelligence engine. For example, the AI engine(s) 302 select a mode that indicates a number of responses that are estimated to resolve a given complaint. For example, the number of responses is a complexity score.

For example, the method can include obtaining, by the computing system from the device, the communication. For example, the communication includes a document that is associated with a process. For example, the communication includes a document that is associated with a complaint. For example, the communication includes a document that is associated with a customer. For example, the method can include the communication structured according to a communication protocol among a plurality of communication protocols. For example, a communication protocol is one of 5G, Internet protocol, JSON, binary, hexadecimal, or any combination thereof. For example, the method can include the communication metric indicating a type of communication channel corresponding to the communication protocol. For example, the communication metric is a number “1” that designates a text message channel or text string “TXT” that designates the text message channel. For example, the communication metric is a number “2” that designates a call center voice channel or text string “CTR” that designates the call center voice channel.

For example, the method can include segmenting, by the computer system, the one or more objects into a subset of the one or more objects, the subset corresponding to a subset of at least one of the one or more actions or the flow. For example, segmenting is copying one or more documents to a given folder or directory at a given comping device. For example, segmenting is linking one or more documents to a given folder or directory at a given comping device. For example, segmenting is filtering one or more documents in a given folder or directory at a given comping device. For example, the method can include the flow object corresponding to the subset of at least one of the one or more actions or the flow. For example, the flow object is a portion of a flowchart for a personnel hiring process that is directed to interview processes. For example, the method can include the summary object corresponding to the subset of at least one of the one or more actions or the flow. For example, the summary object includes text that summarizes the portion of the flowchart for the personnel hiring process that is directed to interview processes.

For example, the method can include the characteristics indicating at least one of content having the structure according to natural language or metadata corresponding to the one or more actions. For example, the structure according to natural language is an order of text characters organized in English language. For example, metadata is a link to a document that is the basis for a given action. For example, the method can include the first artificial intelligence engine configured to execute a machine learning model, and the second artificial intelligence engine configured to execute a large language model. For example, the AI engine 302 is configured to execute a machine learning model by an ML engine and is configured to execute a large language model by an LLM engine.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions, and embodiment of the embodiments without departing from the scope of the present disclosure as expressed in the appended claims.

What is claimed is:

1. A method, comprising:
identifying, by a computing system, a communication metric corresponding to a type of a communication from a device interacting with the computing system;
extracting, by the computing system and from the communication, one or more instructions having a natural language structure;
generating, by the computing system and based on the one or more instructions and the natural language structure, a sentiment metric that indicates a characteristic of the interaction between the device and the computing system;
selecting, by the computing system and based on the communication metric and the sentiment metric, a mode of operation of an artificial intelligence circuit of the computing system; and
generating, by the computing system and via the artificial intelligence circuit operating according to the selected mode of operation, one or more responses having the natural language structure based on the one or more instructions.

2. The method of claim 1, wherein the mode of operation is a next best action.

3. The method of claim 1, further comprising:
generating the sentiment metric based on customer complaint data.

4. The method of claim 1, further comprising:
simplifying the one or more responses according to natural language.

5. The method of claim 1, further comprising:
obtaining, by the computing system, one or more documents fitting a domain, the one or more documents having the natural language structure and describing one or more actions of a flow; and
generating, by the computing system and via a first artificial intelligence engine receiving one or more of the characteristics as an input, a flow object having a structure according to the one or more actions of the flow.

6. The method of claim 5, further comprising:
generating, by the computing system and via a second artificial intelligence engine receiving the flow object as an input, a summary object including a text description of the flow.

7. The method of claim 6, wherein the first artificial intelligence engine is configured to execute a machine learning model, and wherein the second artificial intelligence engine is configured to execute a large language model.

8. The method of claim 5, further comprising:
segmenting, by the computer system, the one or more documents into a subset of at least one of the one or more actions.

9. The method of claim 5, wherein the flow object corresponds to the subset of at least one of the one or more actions.

10. A computing system, comprising:
one or more processors configured to:
identify a communication metric corresponding to a type of a communication from a device interacting with the computing system;
extract, from the communication, one or more instructions having a natural language structure;
generate, based on the one or more instructions and the natural language structure, a sentiment metric that indicates a characteristic of the interaction between the device and the computing system;
select, based on the communication metric and the sentiment metric, a mode of operation of an artificial intelligence circuit of the computing system; and
generate, via the artificial intelligence circuit operating according to the selected mode of operation, one or more responses having the natural language structure based on the one or more instructions.

11. The computing system of claim 10, wherein the mode of operation is a next best action.

12. The computing system of claim 10, wherein the one or more processors are further configured to:
generate the sentiment metric based on customer complaint data.

13. The computing system of claim 10, wherein the one or more processors are further configured to:
simplify the one or more responses according to natural language.

14. The computing system of claim 10, wherein the one or more processors are further configured to:
obtain one or more documents fitting a domain, the one or more documents having the natural language structure and describing one or more actions of a flow; and
generate, via a first artificial intelligence engine receiving one or more of the characteristics as an input, a flow object having a structure according to the one or more actions of the flow.

15. The computing system of claim 14, wherein the one or more processors are further configured to:
generate, via a second artificial intelligence engine receiving the flow object as an input, a summary object including a text description of the flow.

16. The computing system of claim 15, wherein the first artificial intelligence engine is configured to execute a machine learning model, and wherein the second artificial intelligence engine is configured to execute a large language model.

17. The computing system of claim 14, wherein the one or more processors are further configured to:
segment the one or more documents into a subset of the one or more actions.

18. The computing system of claim 14, wherein the flow object corresponds to the subset of at least one of the one or more actions.

19. A non-transitory computer readable medium storing instructions that, when executed by one or more processors of a computing system, cause the computing system to perform operations comprising:
identifying a communication metric corresponding to a type of a communication from a device interacting with the computing system;
extracting, from the communication, one or more instructions having a structure according to natural language;
generating, based on the one or more instructions and the structure, a sentiment metric that indicates a characteristic of the interaction between the device and the computing system;
selecting, based on the communication metric and the sentiment metric, a mode of operation of an artificial intelligence circuit of the computing system; and
generating, using the artificial intelligence circuit operating according to the selected mode of operation, one or more responses having the structure based on the one or more instructions.

20. The non-transitory computer readable medium of claim 19, wherein the instructions, when executed by the one or more processors of the computing system, further cause the computing system to perform operations comprising:
obtaining one or more documents fitting a domain, the documents having the natural language structure and describing one or more actions of a flow; and
generating, via a first artificial intelligence engine receiving one or more of the characteristics as an input, a flow object having a structure according to the one or more actions of the flow.
